(19) United States
(12) Patent Application Publication
(10) Pub. No.: US 2002/0056141 A1
(43) Pub. Date: May 9, 2002

(54) Two way cable system with noise-free return path

(75) Inventor: Abdul-Karim Lakhani, Burnaby (CA)

Correspondence Address: Herbert M. Shapiro, 29091 Pompano Way, Laguna Niguel, CA, 92677, US

(73) Assignee: Advanced Interactive Inc.

(21) Appl. No.: 09/798,507

(22) Filed: Mar. 3, 2001

Related U.S. Application Data
(63) Continuation-in-part of application No. 09/541,187, filed on Apr. 3, 2000.

(51) Int. Cl. H04N 7/16

(52) U.S. Cl. 725/148

(57) ABSTRACT

A cable system is configured for eliminating ingress noise by configuring set top boxes to transmit at a high frequency at which the noise is absent, by converting those high frequency signals to low frequency signals via a converter at the feeder line end, and by reconverting the low frequency signals to high frequency signals via a converter connecting the feeder line to the trunk. The end of the trunk is connected directly back to the node so that the signals from the feeder line travel in the “forward” direction back to the node and thus to the cable headend.

### REFERENCE TO RELATED APPLICATIONS

This application is a Continuation-in-Part of patent application Ser. No. 09/541,187, filed Apr. 3, 2000 for the inventor herein.

### FIELD OF THE INVENTION

This invention relates to cable systems and more particularly to such systems with a sufficiently noise free return path to support two-way broadband, multimedia content delivery to and from the home.

### BACKGROUND OF THE INVENTION

It is well known that the return path in a cable system is noisy and is frequently referred to as a “noise funnel”. There are three primary sources of such noise: Thermal, fiber optic link and ingress. Thermal noise is generated in each of the active components (amplifiers and receivers). The fiber optic link noise is generated in the return laser, fiber and headend receiver. Ingress noise arises through home wiring and connections and constitutes the major source of noise. A complete discussion of the return path and the noise characteristics is provided in “Return Systems for Hybrid Fiber/Coax Cable TV Networks” by Donald Raskin and Dean Stoneback, 1998 Prentice Hall, Inc.

Every cable system has at least one major trunk along which signals are transmitted from a headend in a forward direction to set-top boxes located in homes or facilities connected to the trunk. The connections of the set-top boxes to the trunk is provided by connecting each set-top box to a feeder line. Each feeder line is connected between a tap or Bridger amplifier in the trunk and a feeder line end. In the usual organization of a cable system there are many set-top boxes connected to each feeder line. Moreover, each feeder line includes bi-directional amplifiers which pass signals in a high frequency band and in a low frequency band in forward and return directions respectively as is well understood in the art. Signals in the low frequency band originate at set-top boxes.

The problem, seemingly intractable, with present return paths in cable systems arises from the fact that the path from the tap in the feeder line to the set-top box is characterized by an unacceptable level of (ingress) noise for signals in the low frequency band in which the set-top box normally transmits. Further, no other band (free of such ingress noise) is available for set-top box transmissions. Present cable systems are wedded to transmission from the cable headend in a high frequency band and transmissions from set-top boxes in a low frequency band.

Yet the financial expectations of two way, broadband channels via a cable systems are so compelling that significant resources are being dedicated towards solving the ingress noise problems in the return paths. The present remedial solutions are expensive, cause system shut down, cause system instability, require repeated trunk rolls to subscribers facilities, and frequent home rewiring. Moreover, home movement with changing weather, electrical connection loosening and the like ensure that repeated attention by cable operators is likely.

Specifically, in the last few years the cable industry has started retrofitting its cable infrastructure to allow for two-way communications on the cable plants. This is referred to in the industry as activating the return path, the return path being in the 5-40 MHz frequency band. The design of the return path was initially done in the late 70's. In the late 80's the bigger cable companies modified their system from using just co-axial cable to a hybrid fiber/co-axial cable system (HFC). This changeover enabled the cable companies to increase the frequency band from 50-350 MHz plants to 50-750 MHz plants, in some cases all the way up to 850 MHz. The increased frequency band allows the cable companies to offer more channels of video services. The increase bandwidth also can be used for digital services in the forward direction. By now activating the return path, two-way services such as impulse pay-per view, interactive TV, cable modems, telephone service, and other additional services can be offered.

In the activation of the return path, it has been noticed by most of the cable companies that the 5-40 MHz frequency band is extremely noisy. Because of the presence of the noise, the only services presently available in the lower frequency band are digital services that can work with low carrier to noise signal levels. Still a large number of companies are currently looking at fixing the problems in the 5-40 MHz frequency band. Most of the approaches have been to reduce the number of homes connected to each node thereby reducing the amount of noise collected in each node. There have also been approaches involving the installation of 5-50 MHz blocking filters to non two-way services subscribers' homes to reduce the noise from those subscribers' homes in the 5-50 MHz band from entering the main cable distribution network. As more subscribers subscribe to two way services, the 5-50 MHz blocking filters had to be removed and this caused further noise. In effect, the more successful the cable companies are at attracting subscribers for two way services, the worse the noise problem becomes on the cable distribution network. The current best approach is to divide the cable system into nodes which service fifteen homes, in effect, providing a system of small clusters of homes each connected directly to the cable headend.

The above-captioned copending application discloses techniques for eliminating the noise which occurs between a set-top box and a tap to the feeder line when signals are transmitted from a set-top box in the 0 to 50 megahertz frequency range. The noise is eliminated by adding a blocking filter in the 5-50 MHz range in the drop cable to the subscriber's home, configuring the set-top box to transmit at frequencies in the 50 to 750 MHz range, receiving those signals at a receiver at the end of the feeder line to which the set-top box is connected and regenerating the received signals at a frequency in the 5 to 50 MHz range for transmission to the cable headend. That application is incorporated herein by reference.

### BRIEF DESCRIPTION OF THE INVENTION

In accordance with the principles of this invention, a set top box is configured to transmit at the higher frequency (50 to 750 MHz or above) and the receiver and transmitter are located at the feeder line ends as disclosed in the above-noted patent application. But the end of the associated trunk line in accordance with the present invention is connected directly back to the node via a cable or via an optical fiber.

In addition, and importantly, each feeder line is connected to the trunk line by means of a low to high frequency converter. High frequency signals from a set-top box are thus transmitted “forward” along a feeder line where they are received and retransmitted at a low frequency which are passed by the reverse amplifiers in the feeder line. But at the junction of a feeder line and the trunk line, a low to high converter retransmits the signals at the high frequency for transmission in the “forward” direction for delivery to the node via the new connection between the trunk end and the node in accordance with the principles of this invention.

The conversion of the low to high frequency of the signals from the feeder line end permits the signals to go forward via the new transmission path provided from the trunk end to the associated node rather than having the signals at the low frequency travel to the node along the conventional return path along the trunk. The advantages to the present solution is that the reverse amplifiers can be omitted in the trunk line and each feeder line return can be carried forward separately in the main trunk thereby eliminating the accumulation of noise in the return path (i.e. “noise funnel). The latter advantage results in a significant increase in bandwidth since single frequency space can be shared by the two-way communication devices connected to each feeder line. That is to say, an allocated frequency space can be used for all the feeder lines because they communicate in different space. In the main trunk, each feeder line return signal is carried in a different frequency spectrum.

### BRIEF DESCRIPTION OF THE DRAWING

FIG. 1 is a schematic representation of a cable system in accordance with the principles of this invention;

FIGS. 2, 3, 4 and 5 are diagrams of frequency spectrums on the trunk, and at the beginning and end of feeder lines of the system of FIG. 1.

### DETAILED DESCRIPTION OF AN ILLUSTRATIVE EMBODIMENT OF THIS INVENTION

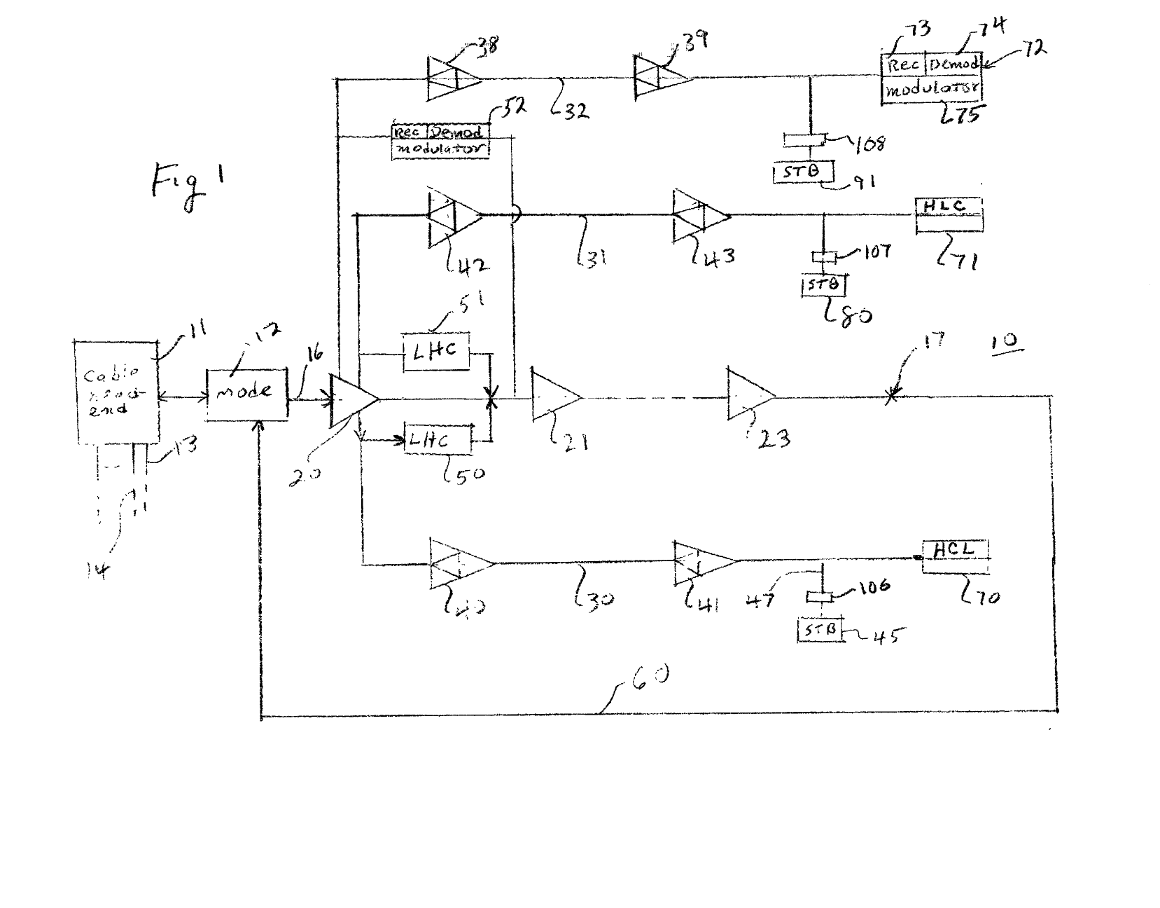

FIG. 1 shows an illustrative portion 10 of a cable system in accordance with the principles of this invention. The portion includes a cable headend 11 and an illustrative node 12. A cable system typically includes many nodes as indicated at 13 and 14.

A trunk line is connected to the node as indicated at 16. Each trunk extends from the node normally to a terminus indicated at 17. The trunk includes a plurality of forward amplifiers 20, 21, 23 typically spaced 500 to 1500 feet apart.

Illustratively, three feeder lines 30, 31 and 32 are connected to trunk 16 at a Bridger amplifier 20. Each feeder line includes a plurality of spaced apart forward and reverse amplifiers represented at 38, 39, 40, 41, 42 and 43. Representative set-top boxes (two-way communication devices) are represented at 45, 80 and 91.

Importantly, in accordance with the principles of this invention, each feeder line is connected to a trunk not only in the familiar fashion at a Bridger amplifier but also by a low-to-high frequency converter (LHC) as indicated at 50 and 51 for feeder lines 30 and 31 respectively. Feeder line 32 is also connected via a Bridger amplifier but also (at its end) by a receiver 73, demodulator 74, and modulator 75 collectively labeled 72. Also, in accordance with the principles of this invention a transmission path 60 is provided from the terminus (17) of the trunk back to the node. This path is provided conveniently by an optical fiber but also could be provided by a common coaxial cable connection or other equivalent means.

Also, in accordance with the principles of this invention, a high-to-low frequency converter (HLC) is located at the end of each feeder line as indicated at 70 and 71 for feeder lines 30 and 31 respectively. At the end of feeder line 32 is a receiver 73, demodulator 74, and modulator 75 that effectively have the same effective feature as the high-to-low frequency converter. The data is received by receiver 72 at the high frequency, data is demodulated and then modulated at a low frequency. Any device that effectively does the same thing as the HLC could be placed at the end of the feeder line and the overall concept of this invention could still be implemented. The end of feeder line can be any place after the last forward amplifier in the feeder line. If there are no two-way communication devices after the last amplifier the previous amplifier can be considered the last effective amplifier.

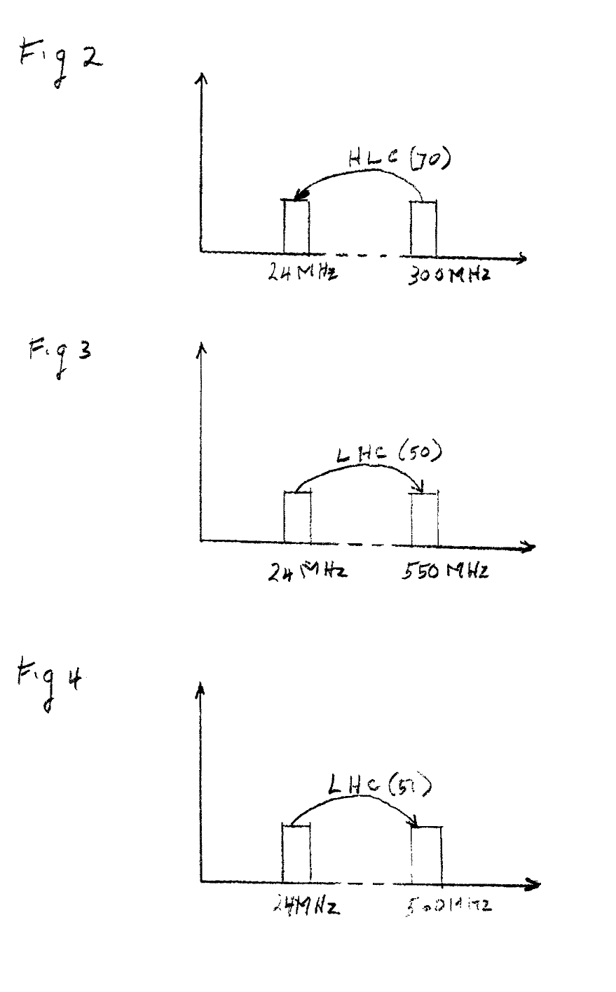

The system of FIG. 1 is operated in a manner to avoid ingress noise. The noise occurs between the set-top box (45) and the connection to the feeder line in the 5 -50 MHz band used for transmissions from a set-top box. High pass (blocking) filters, 106, 107 and 108 are inserted in the drop cables to the subscriber's homes to block all signal in the 5-50 MHz frequency band from entering the feeder lines. A set-top box in the system of FIG. 1 is configured to transmit at a relatively high frequency, illustratively 300 MHz. Of course signals at that frequency are blocked by the reverse amplifiers (at 40 and 41 in feeder line 30). The transmissions instead are directed “forward” to the feeder line end to the converter 70 there. Converter 70 converts the transmissions frequency from 300 MHz to, for example 24 MHz as indicated in FIG. 2. The signals there are transmitted towards the trunk where they are reconverted to 550 MHz by LHC 50. The signals now proceed forward to the trunk end (at 17) and thereafter to node 12 via path 60. FIG. 3 represents the operation of LHC 50 where the LHC reconverts the set-top box transmissions back to a high frequency. The LHC is located after the Bridger amplifier 20 and before the amplifier 40 (i.e. start of feeder line).

A similar operation occurs for a set-top box connected to feeder line 31 as indicated at 80. Set-top box 80 is configured to transmit at, for example, 300 MHz as was the case with set-top box 45. The transmissions are converted by HLC to, for example, 24 MHz as was the case with HLC 70. The now low frequency signals travel to the trunk where they are reconverted to a high frequency for transmission (forward) along the trunk and path 60 to node 12.

A similar operation occurs for a set-top box connected to feeder line 32 as indicated at 91. Set-top box 91 is configured to transmit at, for example, 300 MHz as was the case with set-top box 45. The transmissions are received by receiver 73, the data is demodulated by demodulator 74, and modulated at lower frequency by modulator 75. Set-top box 80 may be a prior art set-top box transmitting in the 5-40 MHz frequency band. The transmission from set-top box 80 at 24 MHz is received by LHC 50. LHC 50 converts the received signal to the 550 MHz frequency band.

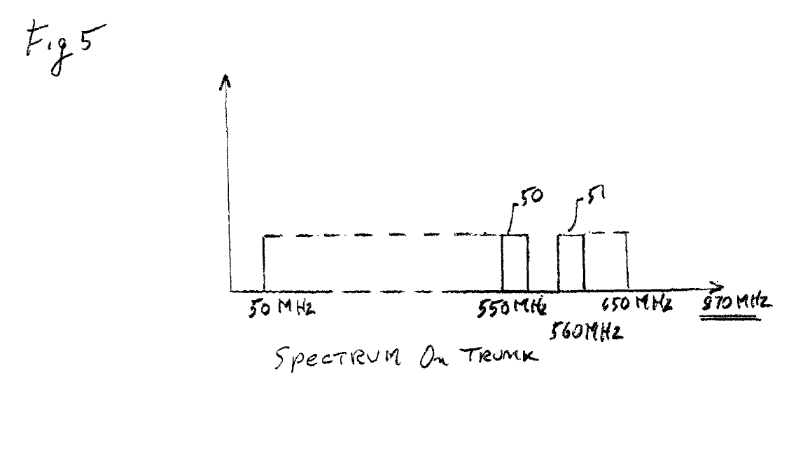

It is important to note that LHC 51 converts the low frequency transmissions from a set-top box to a high frequency of 560 MHz as shown in FIG. 4 where LHC 50 converts set-top box transmissions to 550 MHz as shown in FIG. 3. In fact, the system of FIG. 1 permits each of the typically tens of feeder lines connected to a trunk to have an individual frequency allocated to it. Accordingly, the return path provided by the system of FIG. 1 not only is virtually noise free, but also has effectively a significantly broader band than the return path in a prior art system.

FIG. 5 is a graphical representation of the frequency spectrum on trunk 16. Pulse forms at 550 and 560 are designated 50 and 51 as are the converters (in feeder lines 30 and 31) which provide the pulse forms. The trunk is configured to transmit signals from 50 MHz up to 870 MHz as indicated in the figure. The feeder lines might only have a forward frequency spectrum from say 50 to 540 MHz. It is clear that there is considerable frequency space in the “return” path of the system of FIG. 1 in the main trunk to allocate a different frequency for each feeder line connected to a node. It is also clear that the same opportunity for frequency allocation is available for each node in such a system without interference with like frequency allocations for feeder lines connected to other nodes in the system.

The positions shown for the converters 70 and 71 may be made at any point after the last effective amplifier in the feeder line. The connection of path 60 to the trunk may be made at any point after the last amplifier in the trunk.

In normal operation of the system of FIG. 1, transmissions from the cable headend occur at a high frequency as is well understood. The various set-top boxes are typically poled by the headend and provided with a period for response. The system of FIG. 1 is responsive to cable headend transmissions to respond as described herein to provide the relatively huge frequency space for “return” signals which are virtually free of noise.

What has been described is merely illustrative of the invention and various modifications thereof can be provided by one skilled in the art within the scope and purview of the invention as claimed. The set-top boxes could equally well be cable modem or other such communication devices and principles of this invention would still apply. For illustrative purposes a forward and reverse split at 50 MHz has been shown in the preferred embodiment. The forward and reverse split could be at another frequency and the principles of this invention would still apply.

What is claim is

1. A cable system including a plurality of feeder lines and a trunk, at least one of said feeder lines having a first end connected to said trunk via a low-to-high converter and having at a second end thereof a high-to-low converter.

2. A system as in claim 1 also including at least one two-way communication device connected to said one feeder line, said device being configured to transmit at a high frequency.

3. A system as in claim 2 wherein said device comprises a set top box.

4. A system as in claim 1 wherein each of said feeder lines is connected to said trunk via a low to high converter and has at a second end thereof a high to low converter and the low-to-high converter in each of said feeder lines converts signals to a different high frequency from that to which converters in other feeder lines convert signals.

5. A system as in claim 1 wherein said trunk includes a plurality of forward amplifiers for amplifying signals in a forward direction from a first end thereof to a second end, said first end being connected to a node, said second end also being connected to said node.

6. A cable system including a headend and at least one node, a trunk connected to said node at a first end thereof and having a plurality of forward amplifiers at spaced apart positions therealong, said system including a plurality of feeder lines connected to said trunk, each of said feeder lines including a plurality of forward amplifiers and a plurality of reverse amplifiers for amplifying signals in a high frequency range and in a low frequency range respectively, each of said feeder lines having a plurality of two-way communication devices connected thereto, each of said devices being configured to transmit in said high frequency range, said trunk having a second end also connected to said node via a transmission path, at least one of said feeder lines including a high-to-low converter at the end thereof, at least one of said feeder lines also being connected to said trunk via a low-to-high converter.

7. A cable system including a headend, said system including at least one trunk having a plurality of taps at spaced-apart positions therealong and at least one feeder line connected to said trunk at a tap, said feeder line having at least one two-way communication device connected thereto between said tap and the feeder line end, said two-way communication device being configured to transmit at a high frequency, a high to low converter located at said feeder line end for receiving high frequency signals from a two-way communication device and for retransmitting the signals at a low frequency, said feeder line also being connected to said trunk line via a low to high converter for receiving high frequency signals from a transmitter at said feeder line end for transmission in a forward direction, said trunk line having an end, said end being connected to said node via a high frequency transmission line.

8. A cable system as in claim 7 wherein said high frequency transmission line comprises an optical fiber.

9. A cable system as in claim 7 including a plurality of said two-way communication devices connected to said feeder line via blocking filters.

10. A cable system as in claim 7 including a plurality of feeder lines connected to Bridger amplifiers in said trunk, each of said feeder lines having a plurality of said two-way communication devices connected to taps therein.

11. A cable system as in claim 10 wherein said two-way communication devices comprise set-top boxes.

12. A cable system as in claim 11 wherein said set-top boxes are configure for generating high frequency transmissions.

13. A cable system as in claim 12 wherein said set-top boxes are connected to taps in said feeder lines via high pass filters.

14. A cable system including a node and at least one trunk, said trunk having a first end connected to said node, said system also including at least one feeder line connected to said trunk via a receiver demodulator modulator arrangement for converting information in a low frequency band to a high frequency band.

15. A cable system as in claim 14 wherein said feeder line includes a receiver demodulator modulator arrangement at the feeder line end thereof for converting information in a high frequency band to a low frequency band.

16. A cable system as in claim 15 including a plurality of said feeder lines.

17. A cable system as in claim 16 including a plurality of two-way communication devices connected to each of said feeder lines via blocking filters.

18. A cable system as in claim 17 wherein each of said two-way communication devices comprises a set-top box, said set-top boxes being configured for generating signals in a high frequency range.

19. A cable system including a headend and at least one node, a trunk connected to said node at a first-end thereof and having a plurality of forward amplifiers, said system including at least one feeder line connected to said trunk, said feeder line including a plurality of forward amplifiers and a plurality of reverse amplifiers for amplifying signals in a high-frequency range and in a low-frequency range respectively, said trunk having a second end also connected to said node via a transmission path.

20. A system as in claim 19 including at least one two-way communication device connected to a tap in said feeder line via a high pass filter that blocks the signals in a low frequency band which are passed by the said reverse amplifiers in the said feeder line.

21. A system as in claim 19 where said feeder line has a first end connected to said trunk via a low-to-high converter.

22. A system as in claim 21 where said feeder line has at a second end thereof a high-to-low converter.

23. A cable system including a headend and at least one node, a trunk connected to said node at a first end thereof and having a plurality of forward amplifiers, said system including a plurality of feeder lines connected to said trunk, at least one of the feeder lines also connected to said trunk via a low-to-high converter.

24. A system as in claim 23 where said feeder line has at a second end thereof a high-to-low converter.

25. A system as in claim 24 wherein each of said feeder lines includes a plurality of forward amplifiers and a plurality of reverse amplifiers for amplifying signals in a high-frequency range and a low frequency range respectively.

26. A system including a plurality of feeder lines and a trunk, at least one of said feeder lines having a first end connected to said trunk via a low-to-high converter.

27. A system as in claim 26 also including at least one two-way communication device connected to said feeder line via a high pass filter, said device being configured to transmit at a high frequency.

28. A system as in claim 26 also including at least one node connected to said trunk, said trunk also having an end, said end being connected to said node via high frequency transmission line.

29. A system as in claim 26 wherein at least one of said feeder lines has at a second end a high-to-low converter.

30. A system as in claim 26 also including at least one two-way communication device connected to said feeder line via a high pass filter, said device being configured to receive and transmit in a high frequency band.

31. A system as in claim 26 wherein said trunk has forward amplifiers and said feeder lines have forward and reverse amplifiers.

32. A cable system as in claim 28 also including at least one two way communication device which is connected to said feeder line via a high-pass filter, said communication device being configured to transmit in a high frequency band.

33. A system as in claim 1 also including at least one two-way communication device connected to said one feeder line via a blocking filter, said device being configured to transmit at a higher frequency than the blocking filter.

34. A system as in claim 4 wherein said trunk includes a plurality of forward amplifiers for amplifying signals in a forward direction from a first-end thereof to a second-end, said feeder lines including a plurality of forward amplifiers for amplifying signals in a forward direction from a first end thereof to a second end and including a plurality of reverse amplifiers for amplifying signals in the lower frequency band in a reverse direction.

35. A system as in claim 34 also including at least one two-way communication device connected to each of said feeder lines via a blocking filter, said device being configured to transmit in a high frequency band blocked by the reverse amplifiers.

36. A system as in claim 35 wherein said trunk's first end is connected to a node, said trunk's second end also being connected to said node.

37. A system as in claim 36 wherein the low-to-high converter at different ends of said feeder lines converts signals to a different high frequency to which converters in other feeder lines convert signals.

38. A system as in claim 6 wherein said devices are connected to said feeder lines via blocking filters.
